(19) United States
(12) Patent Application Publication
(10) Pub. No.: US 2026/0302825 A1
(43) Pub. Date: Oct. 1, 2026

(54) CURRENT CONTROL SYSTEM, CURRENT CONTROL METHOD, AND TEMPERATURE DISTRIBUTION CALCULATION METHOD

(71) Applicant: TOYOTA JIDOSHA KABUSHIKI KAISHA, Toyota-shi (JP)

(72) Inventor: Masataka SATO, Sunto-gun (JP)

(73) Assignee: TOYOTA JIDOSHA KABUSHIKI KAISHA, Toyota-shi (JP)

(21) Appl. No.: 19/454,610

(22) Filed: Jan. 21, 2026

(30) Foreign Application Priority Data
Mar. 26, 2025 (JP) 2025-052113

(51) Int. Cl. H02J 7/90; G01K 1/02; G01K 3/14; H01M 10/0525; H01M 10/44; H01M 10/48

(52) U.S. Cl. CPC H02J 7/977; G01K 1/026; G01K 3/14; H01M 10/0525; H01M 10/443; H01M 10/486

(57) ABSTRACT

The current control system includes a plurality of temperature sensors disposed on a main surface of a power storage cell, and an ECU that controls a charging current of the power storage cell based on measurement values of the temperature sensors. The ECU calculates a temperature distribution of the main surface based on measurement values of the temperature sensors by using a temperature distribution calculation model obtained in advance, calculates a current distribution in the power storage cell based on the temperature distribution, and calculates a value of the charging current that can be input to the power storage cell based on the current distribution.

### CROSS-REFERENCE TO RELATED APPLICATION

This application claims priority to Japanese Patent Application No. 2025-052113 filed on Mar. 26, 2025. The disclosure of the above-identified application, including the specification, drawings, and claims, is incorporated by reference herein in its entirety.

### BACKGROUND

### 1. Technical Field

The present disclosure relates to a current control system, a current control method, and a temperature distribution calculation method.

### 2. Description of Related Art

Japanese Unexamined Patent Application Publication No. 2021-090287 (JP 2021-090287 A) discloses a secondary battery control system including a battery temperature prediction unit that predicts a battery temperature of a secondary battery, and a heating support unit that issues an instruction to heat the secondary battery based on the battery temperature predicted by the battery temperature prediction unit. The battery temperature prediction unit predicts the battery temperature of the secondary battery based on a measurement value of a temperature sensor provided inside a battery pack.

### SUMMARY

It is considered that, in a case where a temperature sensor is locally disposed in a power storage cell of a secondary battery, a portion having a relatively large temperature difference from a measurement value of the temperature sensor is provided in the power storage cell. Therefore, in a case where a value of a charging current at which lithium precipitation can be reduced is set based on the measurement value of the temperature sensor, the value of the charging current may be an inappropriate value (a value that is excessively large or excessively small).

The present disclosure has been made to solve the above-described problem, and an object thereof is to provide a current control system and a current control method that are capable of appropriately setting a value of a charging current of a power storage cell.

A current control system relating to a first aspect of the present disclosure is a current control system for controlling a charging current of a power storage cell included in a bipolar lithium-ion secondary battery, the current control system includes
a plurality of temperature measurement units disposed on a surface of the power storage cell, and
a controller configured to control the charging current of the power storage cell based on a measurement value measured by each of the temperature measurement units.

The controller is configured to
calculate, by using a temperature distribution calculation model obtained in advance, a temperature distribution of the surface based on the measurement value of each of the temperature measurement units,
calculate a current distribution in the power storage cell based on the temperature distribution, and
calculate a value of the charging current inputtable to the power storage cell based on the current distribution.

A current control method relating to a second aspect of the present disclosure is a current control method of a current control system for controlling a charging current of a power storage cell included in a bipolar lithium-ion secondary battery, the current control method includes
acquiring a measurement value of each of a plurality of temperature measurement units disposed on a surface of the power storage cell,
calculating, by using a temperature distribution calculation model obtained in advance, a temperature distribution of the surface based on the measurement value of each of the temperature measurement units,
calculating a current distribution in the power storage cell based on the temperature distribution, and
calculating a value of the charging current inputtable to the power storage cell based on the current distribution.

Another object of the present disclosure is to accurately calculate a temperature distribution of a surface of a power storage cell in order to reduce the lithium precipitation, as described above.

A temperature distribution calculation method relating to a temperature distribution calculation method of calculating a temperature distribution of a surface of a power storage cell by using a plurality of temperature measurement units disposed on the surface, the temperature distribution calculation method includes acquiring a first measurement value of a first measurement unit among the temperature measurement units, the first measurement unit being disposed at a first position in a temperature change region in which a temperature increases or decreases as a distance from a predetermined temperature center on the surface increases,
acquiring a second measurement value of a second measurement unit among the temperature measurement units, the second measurement unit being disposed at a second position belonging to a temperature range different from a temperature range of the first position in the temperature change region, and
calculating a temperature at an intermediate position between a first contour and a second contour on the surface based on the first measurement value and the second measurement value, by using a first equation of the first contour on which the first measurement unit is disposed and a second equation of the second contour on which the second measurement unit is disposed, the first contour being determined based on coordinates of the first measurement unit on the surface and a region temperature distribution that is a temperature distribution in the temperature change region, and being a contour of temperatures centered at the temperature center, the second contour being determined based on coordinates of the second measurement unit on the surface and the region temperature distribution, and being a contour of temperatures centered at the temperature center.

With the current control system and the current control method according to the present disclosure, an upper limit value of the charging current is calculated from the current distribution calculated based on the temperature distribution of the power storage cell. As a result, it is possible to determine the upper limit value of the charging current in consideration of a variation in a resistance value caused by the temperature distribution. As a result, it is possible to appropriately set the value of the charging current of the power storage cell. In addition, with the temperature distribution calculation method according to the present disclosure, since it is possible to acquire information on the temperature at the intermediate position where the temperature measurement unit is not disposed, it is possible to accurately calculate the temperature distribution of the surface of the power storage cell.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing a configuration of a current control system according to the present embodiment and an exploded perspective view of a power storage device;

FIG. 2 is a cross-sectional view taken along line II-II of FIG. 1;

FIG. 3 is a diagram showing an example of a simulation result of a temperature distribution of the power storage cell;

FIG. 4 is a plan view showing a main surface of the power storage cell and a temperature sensor disposed on the main surface;

FIG. 5 is a diagram showing an elliptic cone used in a temperature distribution calculation model according to the present embodiment; and

FIG. 6 is a flowchart showing a current control method of the current control system according to the present embodiment.

### DETAILED DESCRIPTION OF EMBODIMENTS

An embodiment of the present disclosure will be described with reference to the drawings. In the drawings to be referred to below, the same or corresponding members are denoted by the same number.

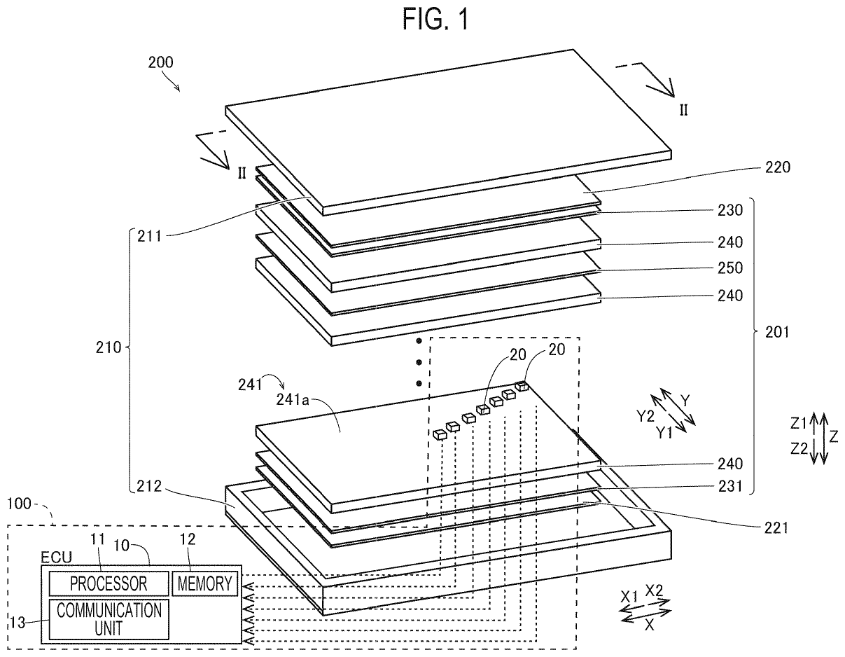

FIG. 1 is an exploded perspective view showing a configuration of a current control system 100 and a power storage device 200 according to the present embodiment. In FIG. 1, a Z direction indicates a lamination direction of a laminate 201 described below. An X direction indicates a width direction of the power storage device 200. A Y direction indicates a depth direction of the power storage device 200. The X direction, the Y direction, and the Z direction are directions orthogonal to each other. The power storage device 200 is mounted in, for example, a vehicle. The application of the power storage device 200 is not limited to a vehicle application.

The power storage device 200 includes a housing case 210, the laminate 201, and insulating films 220, 221. The housing case 210 accommodates the laminate 201 therein and restricts the laminate 201 in the Z direction.

The housing case 210 includes an upper cover 211 and a lower case 212. The upper cover 211 and the lower case 212 are arranged at intervals in the Z direction. The upper cover 211 and the lower case 212 are restricted in the Z direction by a bolt or the like.

The lower case 212 is provided to be open upward. The upper cover 211 is provided to cover an opening portion of the lower case 212.

Each of the insulating films 220, 221 is disposed between the housing case 210 and the laminate 201. Each of the insulating films 220, 221 has electrical insulating properties. As a result, the housing case 210 and the laminate 201 are insulated from each other.

The laminate 201 includes collector plates 230, 231, a plurality of power storage modules 240, and a plurality of conductive intercalation materials 250. The power storage modules 240 are laminated (arranged) in the Z direction with the intercalation materials 250 interposed therebetween.

In the Z direction, the collector plate 230 is disposed at one end of the laminated power storage modules 240. The collector plate 231 is disposed at the other end of the power storage modules 240. With such a configuration, each of the collector plate 230 and the collector plate 231 is in conduction with the power storage module 240. The intercalation materials 250 laminated in the Z direction and the power storage modules 240 are in conduction with each other. As a result, the current in the laminate 201 flows in the Z direction from, for example, the collector plate 230 to the collector plate 231.

The power storage module 240 has a bipolar structure. In a plan view of the power storage module 240 from a position away from the power storage module 240 in the Z direction, the power storage module 240 is provided in a rectangular shape.

Each of the collector plate 230 and the collector plate 231 is connected to a positive electrode terminal and a negative electrode terminal (not shown), respectively. Each of the positive electrode terminal and the negative electrode terminal is connected to an external terminal. As a result, the external terminal and the power storage device 200 are electrically connected to each other, so that the power storage device 200 can be charged and discharged.
the intercalation materials 250 include a cooler through which a refrigerant (for example, coolant or insulating oil) flows and a conduction plate. The cooler includes, for example, a metal such as aluminum and has conductivity.

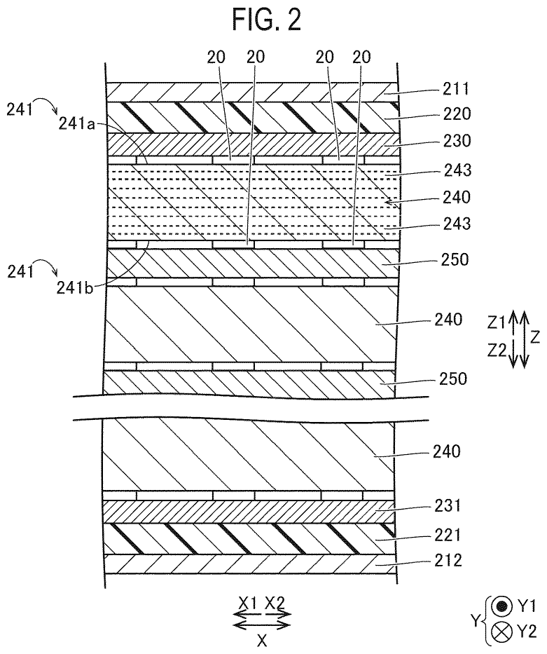

The current control system 100 includes an electronic control unit (ECU) 10 and a plurality of temperature sensors 20. The ECU 10 and the temperature sensor 20 are examples of a “controller” and a “temperature measurement unit” of the present disclosure, respectively.
the temperature sensors 20 are disposed on a main surface 241 of the power storage module 240 orthogonal to the Z direction. The main surface 241 includes a main surface 241a on a Z1 side and a main surface 241b (FIG. 2) on a Z2 side. In FIG. 1, an example is shown in which seven temperature sensors 20 are disposed on the main surface 241a, but the number of the temperature sensors 20 is not limited to this example. The number of the temperature sensors 20 is not limited to seven as long as the number is two or more. In the following, in a case of being described as the main surface 241, the matter corresponds to both the main surface 241a and the main surface 241b. The main surface 241 (241a, 241b) is an example of a “surface” of the present disclosure.

The ECU 10 includes a processor 11, a memory 12, and a communication unit 13. The memory 12 is configured to store the stored information. In addition to the program, the memory 12 stores information (for example, a map, a mathematical expression, and various parameters) used in the program. In the present embodiment, the processor 11 executes the program stored in the memory 12 to execute various types of processing by the ECU 10.

The communication unit 13 receives signals from various devices and various sensors provided in the vehicle. Specifically, the communication unit 13 receives information on the measurement value from each of the temperature sensors 20.

FIG. 2 is a schematic view of a cross-sectional view taken along line II-II of FIG. 1. The main surface 241a and the main surface 241b of the power storage module 240 are each disposed with different temperature sensors 20. In FIG. 2, for simplification, the intercalation materials 250 and the power storage modules 240 are schematically shown not to be in contact with each other, but in reality, the intercalation materials 250 and the power storage modules 240 are in contact with each other.

The power storage device 200 is a bipolar lithium-ion secondary battery. Each of the power storage modules 240 includes a plurality of power storage cells 243 laminated in the Z direction. In FIG. 2, an example is schematically shown in which the number of the power storage cells 243 included in the power storage module 240 is nine. The number of the power storage cells 243 is not limited to this example. The number of the power storage cells 243 included in each of the power storage modules 240 may be, for example, 30. The lithium-ion secondary battery is a battery in which lithium is a charge carrier, and may include not only a lithium-ion secondary battery in which an electrolyte is a liquid but also an all-solid-state battery using a solid electrolyte.

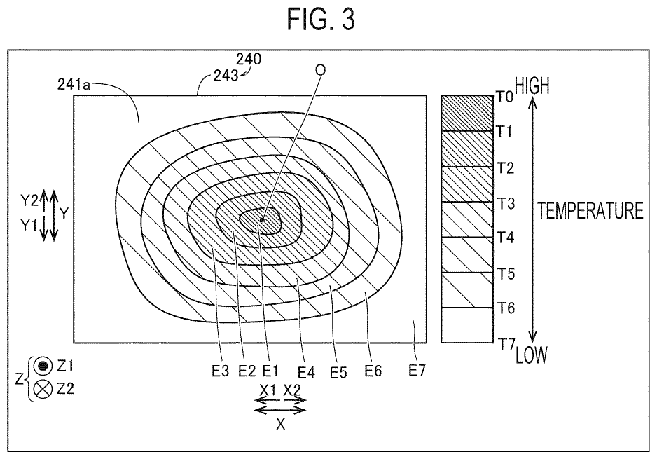

FIG. 3 shows a simulation result of the temperature distribution on the main surface 241a. In the simulation of FIG. 3, it was found that a temperature change region in which the temperature decreases as a distance from a temperature center O increases was generated on the main surface 241a. The simulation result shown in FIG. 3 is merely an example, and a temperature distribution different from the example shown in FIG. 3 may be generated on the main surface 241.

In this simulation, it was found that a region E1 from a temperature T0 to a temperature T1, a region E2 from a temperature T1 to a temperature T2, a region E3 from a temperature T2 to a temperature T3, a region E4 from a temperature T3 to a temperature T4, a region E5 from a temperature T4 to a temperature T5, a region E6 from a temperature T5 to a temperature T6, and a region E7 from a temperature T6 to a temperature T7 were provided on the main surface 241a. The temperature center O is located in the region E1. In the present embodiment, an entirety of the main surface 241a is an example of a “temperature change region” of the present disclosure.

In addition, although not shown, in this simulation, it was found that in a case where the usage time of the power storage device 200 was long, the average temperature on the main surface 241a changed (increased) while the temperature distribution did not change significantly.

Here, in a case where the temperature sensor is locally disposed in the power storage cell, it is considered that a portion having a relatively large temperature difference from the measurement value is provided in the power storage cell. Therefore, in the system of the related art, in a case where the value of the charging current at which the lithium precipitation is suppressed is set based on the measurement value of the temperature sensor, the value of the charging current may be an inappropriate value (a value that is excessively large or small).

Therefore, in the present embodiment, the ECU 10 (FIG. 1) calculates the temperature distribution of the main surface 241 based on the measurement values of the temperature sensors 20 by using the temperature distribution calculation model obtained in advance. In addition, the ECU 10 calculates the current distribution in the power storage cell 243 (power storage module 240) based on the temperature distribution, and calculates the upper limit value of the charging current that can be input to the power storage cell 243 based on the current distribution. Hereinafter, the details will be described.

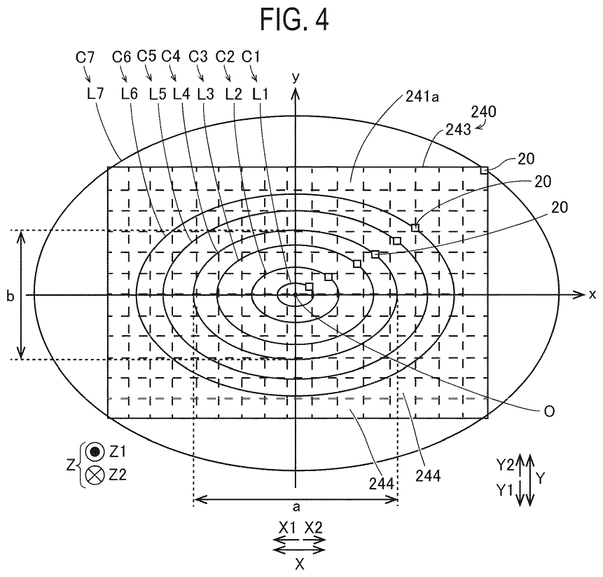

FIG. 4 shows contours L1 to L7 related to the temperature. The shape of each of the contours L1 to L7 follows the shape (elliptical shape in FIG. 3) of the regions E1 to E7. Note that each of the contours L1 to L7 constitutes an outer peripheral edge of an ellipse C1 to C7. The temperature sensor 20 is disposed on each of the contours L1 to L7. The temperature sensors 20 are disposed in regions of the main surface 241 belonging to different temperature ranges. For example, it is preferable that each of the temperature sensors 20 is disposed at a position corresponding to an inflection point of the temperature (a point at which a gradient of the temperature change changes significantly).

In addition, the temperature sensor 20 that is farthest from the temperature center O is disposed at, for example, a corner portion of the main surface 241a. As a result, the outermost ellipse C7 covers substantially the entirety of the main surface 241a. In the present embodiment, since the entirety of the main surface 241a is a temperature change region in which the temperature decreases as the distance from the temperature center O increases, an example is shown in which the outermost ellipse C7 covers substantially the entirety of the main surface 241a, but the present disclosure is not limited to this. In a case where the temperature change region is present only on a part of the surface, the outermost ellipse need only cover the temperature change region.

The ellipses C1 to C7 have similar shapes to each other. A ratio (major axis/minor axis) of a major axis to a minor axis of each of the ellipses C1 to C7 is a/b. The temperature center O is located at the center of each of the ellipses C1 to C7. Here, a first axis and a second axis of a coordinate plane with the temperature center O as the origin are defined as an x-axis and a y-axis, respectively. Hereinafter, the coordinate plane is referred to as an xy plane.

The memory 12 of the ECU 10 stores information on an equation of each of the contours L1 to L7 (ellipses C1 to C7). The memory 12 stores information on a major radius and a minor radius of each of the ellipses C1 to C7.

In addition, in FIG. 4, the main surface 241a is divided into a plurality (192 in the example shown in FIG. 4) of meshes 244. The memory 12 stores information on coordinates of each of the meshes 244 in the xy plane. The number of the meshes 244 is not limited to the example shown in FIG. 4.

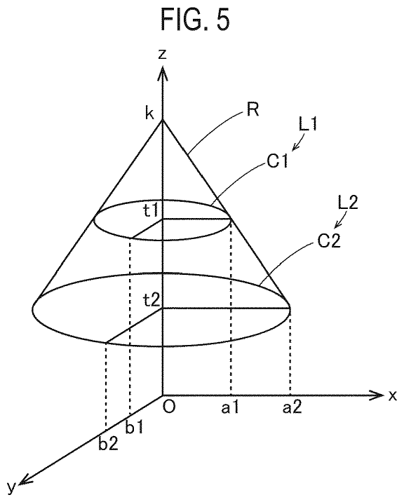

FIG. 5 is a diagram for describing a model for predicting the temperature distribution of the power storage cell 243 by using the equations of the contours L1 to L7. Hereinafter, a method of predicting the temperature distribution by using the contour L1 and the contour L2 will be described.

In FIG. 5, a coordinate space defined by the xy plane and a z-axis orthogonal to the xy plane is shown. In this model, a value of the Z-axis of the ellipse C1 is defined as a measurement value t1 of the temperature sensor 20 disposed on the contour L1, and a value of the Z-axis of the ellipse C2 is defined as a measurement value t2 of the temperature sensor 20 disposed on the contour L2.

The processor 11 of the ECU 10 (FIG. 1) calculates the temperature distribution by using an equation of an elliptic cone R that is a bottom surface orthogonal to the Z-axis of the ellipse C2 and a cross section orthogonal to the Z-axis of the ellipse C1. The equation of the elliptic cone R is represented by Expression (1).

$${x}^{2} / {a}^{2} + {y}^{2} / {b}^{2} = {( k - z )}^{2} / {k}^{2} \qquad ( 1 )$$

Specifically, the processor 11 calculates k of Expression (1). Here, in a case where a major radius and a minor radius of the ellipse C1 are defined as a1 and b1, respectively, and a major radius and a minor radius of the ellipse C2 are defined as a2 and b2, the processor 11 calculates k by using Expression (2). In addition, by calculating k, the equation of the elliptic cone R represented by Expression (2) is determined.

$$k = ( a 2 \times t 1 - a 1 \times t 2 ) / ( a 2 - a 1 ) \qquad ( 2 )$$

The processor 11 calculates a z value (that is, a temperature) of each of the meshes 244 positioned between the contour L1 and the contour L2 based on coordinates of each of the meshes 244 by using Expression (2). The processor 11 also calculates the z value (temperature) of the mesh 244 between the other contours in the same manner as described above. As a result, the processor 11 calculates the temperature distribution of the main surface 241a.

### Charging Current Control Method

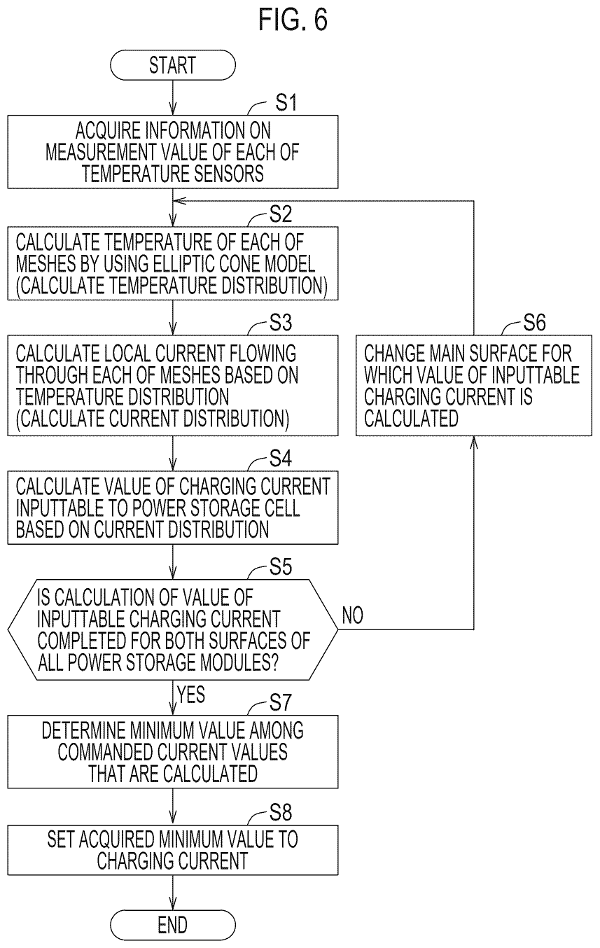

FIG. 6 shows a control flow for controlling the charging current. The control shown in FIG. 6 may be executed by the ECU 10 (processor 11) for each predetermined period (for example, every minute).

In S1, the ECU 10 (processor 11) acquires the information on the measurement value of each of temperature sensors 20 through the communication unit 13. Specifically, the ECU 10 acquires the information on the measurement value of each of the temperature sensors 20 disposed on each of the main surface 241a and the main surface 241b of each of the power storage modules 240.

In S2, the ECU 10 calculates the temperature of each of the meshes 244 corresponding to the main surface 241a of one power storage module 240 by using Expression (1) and Expression (2) using the elliptic cone R. That is, the ECU 10 acquires the temperature distribution of the power storage cell 243 on the main surface 241a side. The temperature of the mesh 244 on which the temperature sensor 20 is disposed is reflected in the temperature distribution by the measurement value of the temperature sensor 20. In S2 in the first loop, the temperature distribution of, for example, the power storage module 240 disposed closest to the Z1 side among the power storage modules 240 may be calculated.

In S3, the ECU 10 calculates a local current Ix flowing through each of meshes 244 based on the temperature distribution calculated in S2. That is, the ECU 10 acquires the current distribution of the power storage cell 243 on the main surface 241a side. Specifically, the ECU 10 calculates the local current Ix by using Expression (3). ΔOCV is a difference (OCVx−OCVall) [V] between an open-circuit voltage (OCVx) that is a local OCV in the mesh 244 and an average value (OCVall) of the OCV of an entirety of the power storage cell 243. Iall is a current [A] flowing through the entirety of the power storage cell 243. Rall is an internal resistance [mΩ] of the entirety of the power storage cell 243. rx is an internal resistance (local resistance) of the mesh 244.

$$Ix = ( Δ OCV + Iall \times Rall ) / rx \qquad ( 3 )$$

Expression (4) is an expression showing a local current density Ix/a based on Expression (3). a is an area (local area) of the mesh 244. Rx is a value obtained by converting the local resistance rx to the entirety of the power storage cell 243 (area conversion). A is an energized area (that is, an area of the main surfaces 241a, 241b) of the entirety of the power storage cell 243.

$$I x / a = ( Δ OCV + Iall \times Rall ) / ( Rx \times A ) \qquad ( 4 )$$

In S4, the ECU 10 calculates a value of the charging current inputtable to the power storage cell 243 (commanded value Iall′ described below) based on the current distribution calculated in S3. Hereinafter, the details will be described.

The ECU 10 calculates Rall by using Expression (5). In addition, the ECU 10 calculates Rx by using Expression (6). The map 1 of Expression (5) and Expression (6) is a predetermined map showing a relationship between the SOC and the temperature and the internal resistance. The information of the map 1 may be stored in the memory 12. In addition, SOCall is an average SOC (state of charge) of the power storage cell 243. SOCx is an SOC (local SOC) of the mesh 244. Tall is an average temperature of the power storage cell 243. Tx is a temperature (local temperature) of each of the meshes 244 calculated in S2. Tall may be an average value of the temperatures of each of the meshes 244 calculated in S2.

$$Rall = map 1 ( SOCall , Tall ) \qquad ( 5 )$$

$$Rx = map 1 ( SOCx , Tx ) \qquad ( 6 )$$

The ECU 10 calculates SOCall by using Expression (7) and Expression (8), and calculates Rall from Expression (5) based on the calculated SOCall. t indicates time. SOCall(t) is an average SOC of the power storage cell 243 at time t. Qall(t) is an amount of electric charge [Ah] stored in the power storage cell 243 between time t−1 and time t. Qall is an electric capacity [Ah] of the power storage cell 243. ∫Iall(t) in Expression (8) is an integrated value [A] of the current flowing through the power storage cell 243 between time t−1 and time t.

$$SOCall ( t ) = SOCall ( t - 1 ) + Qall ( t ) / Qall \times 100 \qquad ( 7 )$$

$$Qall ( t ) = \int Iall ( t ) dt \qquad ( 8 )$$

The ECU 10 calculates SOCx by using Expression (9) and Expression (10), and calculates Rx from Expression (6) based on the calculated SOCx. SOCx(t) is an SOC of the mesh 244 at time t. Qx(t) is an amount of electric charge [Ah] stored in the mesh 244 between time t−1 and time t. Qx is an electric capacity [Ah] of the mesh 244. Qx is a value obtained by dividing Qall by the number of the meshes 244. ∫Ix(t) in Expression (10) is an integrated value [A] of the current flowing through the mesh 244 between time t−1 and time t.

$$SOCx ( t ) = SOCx ( t - 1 ) + Qx ( t ) / Qx \times 100 \qquad ( 9 )$$

$$Qx ( t ) = \int Ix ( t ) dt \qquad ( 10 )$$

The ECU 10 calculates the local current density Ix/a by using Expression (4) based on Rall and Rx calculated by Expression (5) and Expression (6). The ECU 10 calculates the local current Ix by using Expression (3) based on the calculated local current density Ix/a.

The ECU 10 calculates the charging current upper limit value Ilimx for each of the meshes 244 by using Expression (11) based on the SOCx calculated by Expression (9) and the temperature Tx of each of the meshes 244 calculated in S2. The map 2 of Expression (11) is a map showing a relationship between the SOC and the temperature and the charging current upper limit value of the entirety of the power storage cell 243. The map 2 is predetermined and is stored in, for example, the memory 12 (FIG. 1).

$$Ilimx = map 2 ( SOCx , Tx ) \times a / A \qquad ( 11 )$$

The ECU 10 calculates Idltx for each of the meshes 244 by using Expression (12). Idltx is a product value ((Ilimx−Ix)×Iall/Ix) of a difference between the charging current upper limit value Ilimx calculated by Expression (11) and the local current Ix calculated by Expression (3) and a ratio (Iall/Ix) of the total current Iall to the local current Ix. The ECU 10 calculates Ildt that is a minimum value of Idltx calculated for each of the meshes 244, by using Expression (13).

$$Idltx = ( Ilimx - Ix ) \times Iall / Ix \qquad ( 12 )$$

$$Idlt = MIN ( Idltx ) \qquad ( 13 )$$

The ECU 10 calculates the charging current upper limit value Ilimall at the average temperature of the power storage cell 243 based on the SOCall and the Tall of the power storage cell 243 by using Expression (14).

$$Ilimall = map 2 ( SOCall , Tall ) \qquad ( 14 )$$

In S5 shown in FIG. 6, the ECU 10 calculates Iall′ by using Expression (15) based on the Idlt calculated by Expression (13) and the Ilimall calculated by Expression (14). Iall′ is a commanded value of a value of the current to be energized to the entirety of the power storage cell 243. Ilimall is corrected based on the excess amount (Ilimx−Ix) of the mesh 244 in which the local current Ix exceeds the charging current upper limit value Ilimx most in the meshes 244 by Expression (15). As a result, Iall′ is calculated. Iall′ is an example of “a value of an inputtable charging current” of the present disclosure.

$${Iall}^{′} = Ilimall + Idlt \qquad ( 15 )$$

In S5, the ECU 10 determines whether the calculation of the commanded value (Iall′) of the current is completed for each of the main surface 241a and the main surface 241b of all the power storage modules 240. In a case where the calculation is completed (Yes in S5), the process proceeds to S7. In a case where the calculation is not completed (No in S5), the process proceeds to S6.

In S6, the ECU 10 changes the main surface 241 for which Iall′ is calculated.

Specifically, the ECU 10 selects the main surface 241 on which the calculation of Iall′ is not executed. The ECU 10 may select the main surface 241 on which Iall′ is calculated in order from the Z1 side, for example.

In S7, the ECU 10 determines which of the commanded values (Iall′) corresponding to the main surface 241 of each of the calculated power storage modules 240 is the minimum value.

In S8, the ECU 10 sets the minimum value determined in S7 to the charging current to be energized to the laminate 201. As a result, the control flow of FIG. 6 ends.

As described above, in the present embodiment, the ECU 10 calculates the temperature distribution of the main surface 241 based on the measurement values of the temperature sensors 20 by using the temperature distribution calculation model obtained in advance. In addition, the ECU 10 calculates the current distribution in the power storage cell 243 based on the temperature distribution, and calculates the value of the charging current that can be input to the power storage cell 243 based on the current distribution. As a result, the value of the charging current can be set in consideration of the current flowing through a portion in which the temperature sensor 20 is not provided, unlike a case where the value of the charging current is set based only on the temperature of the local portion of the power storage cell 243. As a result, the lithium precipitation in the portion can be suppressed, and the value of the charging current can be prevented from being excessively small.

In addition, in the present embodiment, the ECU 10 measures the temperature at the intermediate position between the adjacent contours (for example, the contours L1 and L2) by using the temperature distribution calculation model. The temperature distribution calculation model is a model that measures the temperature at the intermediate position based on the measurement value of the temperature sensor 20 disposed on each of the contours by using the equation of each of the contours. As a result, by using the temperature distribution prediction model, the temperature of each of the meshes 244 can be calculated, so that the temperature distribution of the power storage cell 243 can be accurately calculated. In addition, even in a case where the temperature sensor 20 is not disposed in each of the meshes 244, the temperature of each of the meshes 244 can be calculated (predicted) by using only a limited number of temperature sensors 20. As a result, the number of components can be reduced.

### Modification

In the above-described embodiment, the example has been described in which the temperature sensor 20 is disposed on each of the main surface 241a and the main surface 241b of the power storage module 240, but the present disclosure is not limited to this. The temperature sensor 20 may be disposed on only one of the main surface 241a or the main surface 241b. In addition, the temperature sensor 20 may be disposed in only one of the power storage modules 240.

In the above-described embodiment, the example has been described in which each of the contours constitutes an outer peripheral edge of an ellipse, but the present disclosure is not limited to this. Each of the contours may constitute an outer peripheral edge of a figure (for example, a perfect circle and a polygon) other than an ellipse.

In the above-described embodiment, the example has been described in which only one temperature center O is present on the main surface of the power storage cell 243, but the present disclosure is not limited to this. A plurality of temperature centers O may be present on the main surface of the power storage cell 243. In this case, the equation of the contour is calculated for each of the temperature centers O. The above-described equation may be calculated assuming that each of the temperature centers O is disposed at different planar coordinates. In addition, the above-described equation may be calculated assuming that each of the temperature centers O is disposed at the same planar coordinates.

In the above-described embodiment, the example has been described in which the temperature sensor 20 is disposed only on each of the contours L1 to L7, but the present disclosure is not limited to this. For example, the temperature sensor 20 may be disposed at the temperature center O. In addition, the temperature of the region inside the innermost ellipse C1 may be regarded as being equal to the measurement value of the temperature sensor 20 disposed on the contour L1.

In the above-described embodiment, the example has been described in which the equations of the contours L1 to L7 are stored in advance in the memory 12 or the like, but the present disclosure is not limited to this. The processor 11 may calculate the equations of the contours L1 to L7.

In the above-described embodiment, the example has been described in which the temperature distribution (current distribution) and the value of the charging current are calculated in order for each main surface 241, but the present disclosure is not limited to this. The above-described calculation may be performed simultaneously for all the main surfaces 241.

In the above-described embodiment, the example has been described in which the equations of the contours L1 to L7 used for calculating the temperature distribution are uniformly determined, but the present disclosure is not limited to this. For example, the above-described equation may be different between a cooling time and a temperature rising time of the power storage device 200. In addition, the above-described equation may be different depending on a mode (flow passage of the refrigerant) during cooling, a mode (flow passage of the refrigerant) during temperature rise, or the like. In this case, the temperature sensor 20 used to calculate the temperature distribution corresponding to each mode may be common or may be different from each other.

It should be noted that the embodiment disclosed this time is merely an example in all aspects, and should not be construed as limiting. The scope of the present disclosure is defined not by the above-described embodiment but by the claims, and all equivalents and all modifications within the scope of the claims are included.

What is claimed is:

1. A current control system for controlling a charging current of a power storage cell included in a bipolar lithium-ion secondary battery, the current control system comprising:
a plurality of temperature measurement units disposed on a surface of the power storage cell; and
a controller configured to control the charging current of the power storage cell based on a measurement value measured by each of the temperature measurement units,
wherein the controller is configured to
calculate, by using a temperature distribution calculation model obtained in advance, a temperature distribution of the surface based on the measurement value of each of the temperature measurement units,
calculate a current distribution in the power storage cell based on the temperature distribution, and
calculate a value of the charging current inputtable to the power storage cell based on the current distribution.

2. The current control system according to claim 1, wherein:
each of the temperature measurement units is disposed in a temperature change region in which a temperature increases or decreases as a distance from a predetermined temperature center on the surface increases;
the temperature measurement units include
a first measurement unit disposed at a first position in the temperature change region, and
a second measurement unit disposed at a second position belonging to a temperature range different from a temperature range of the first position in the temperature change region; and
when a temperature distribution in the temperature change region is a region temperature distribution,
an equation of a first contour on which the first measurement unit is disposed is a first equation, the first contour being determined based on coordinates of the first measurement unit on the surface and the region temperature distribution, and being a contour of temperatures centered at the temperature center, and
an equation of a second contour on which the second measurement unit is disposed is a second equation, the second contour being determined based on coordinates of the second measurement unit on the surface and the region temperature distribution, and being a contour of temperatures centered at the temperature center,
the temperature distribution calculation model is a model for calculating, by using th first equation and the second equation, a temperature at an intermediate position between the first contour and the second contour on the surface based on a first measurement value of the first measurement unit and a second measurement value of the second measurement unit.

3. A current control method of a current control system for controlling a charging current of a power storage cell included in a bipolar lithium-ion secondary battery, the current control method comprising:
acquiring a measurement value of each of a plurality of temperature measurement units disposed on a surface of the power storage cell;
calculating, by using a temperature distribution calculation model obtained in advance, a temperature distribution of the surface based on the measurement value of each of the temperature measurement units;
calculating a current distribution in the power storage cell based on the temperature distribution; and
calculating a value of the charging current inputtable to the power storage cell based on the current distribution.

4. The current control method according to claim 3, wherein, when the temperature measurement units include a first measurement unit and a second measurement unit, the calculating of the temperature distribution includes
acquiring a first measurement value of the first measurement unit among the temperature measurement units, the first measurement unit being disposed at a first position in a temperature change region in which a temperature increases or decreases as a distance from a predetermined temperature center on the surface increases,
acquiring a second measurement value of the second measurement unit among the temperature measurement units, the second measurement unit being disposed at a second position belonging to a temperature range different from a temperature range of the first position in the temperature change region, and
calculating a temperature at an intermediate position between a first contour and a second contour on the surface based on the first measurement value and the second measurement value, by using a first equation of the first contour on which the first measurement unit is disposed and a second equation of the second contour on which the second measurement unit is disposed, the first contour being determined based on coordinates of the first measurement unit on the surface and a region temperature distribution that is a temperature distribution in the temperature change region, and being a contour of temperatures centered at the temperature center, the second contour being determined based on coordinates of the second measurement unit on the surface and the region temperature distribution, and being a contour of temperatures centered at the temperature center.

5. A temperature distribution calculation method of calculating a temperature distribution of a surface of a power storage cell by using a plurality of temperature measurement units disposed on the surface, the temperature distribution calculation method comprising:
acquiring a first measurement value of a first measurement unit among the temperature measurement units, the first measurement unit being disposed at a first position in a temperature change region in which a temperature increases or decreases as a distance from a predetermined temperature center on the surface increases;
acquiring a second measurement value of a second measurement unit among the temperature measurement units, the second measurement unit being disposed at a second position belonging to a temperature range different from a temperature range of the first position in the temperature change region; and
calculating a temperature at an intermediate position between a first contour and a second contour on the surface based on the first measurement value and the second measurement value, by using a first equation of the first contour on which the first measurement unit is disposed and a second equation of the second contour on which the second measurement unit is disposed, the first contour being determined based on coordinates of the first measurement unit on the surface and a region temperature distribution that is a temperature distribution in the temperature change region, and being a contour of temperatures centered at the temperature center, the second contour being determined based on coordinates of the second measurement unit on the surface and the region temperature distribution, and being a contour of temperatures centered at the temperature center.
